(19) United States
(12) Patent Application Publication
(10) Pub. No.: US 2008/0080179 A1
(43) Pub. Date: Apr. 3, 2008

(54) LED floodlight structure

(75) Inventor: Gabriele Giorgi, Gabicce Mare PU (IT)

Correspondence Address: COHEN, PONTANI, LIEBERMAN & PAVANE, 551 FIFTH AVENUE, SUITE 1210, NEW YORK, NY, 10176, US

(73) Assignee: SGM Technology For Lighting S.p.A., Tavullia PU (IT)

(21) Appl. No.: 11/881,900

(22) Filed: Jul. 30, 2007

(30) Foreign Application Priority Data
Oct. 3, 2006 (IT) PS2006 U 000016

(51) Int. Cl. F21V 14/06

(52) U.S. Cl. 362/232

(57) ABSTRACT

An LED floodlight structure comprising an optical focus variation system composed of a matte screen with adjustable excursion on whose surface are mounted a multiplicity of lenses assembled distally within respective parallel telescopic tubes fitted in correspondence to the light sources.

### BACKGROUND OF THE INVENTION

1. Field of the Invention

The present invention is directed to an LED Floodlight Structure.

2. Description of the Related Art

An LED, or Light Emitting Diode, is an electronic light source based on the phenomenon known as “electroluminescence” which, unlike conventional incandescent light sources that operate at high temperatures and are characterised by considerable thermal inertia, emits “cold light” and has the advantages of being able to flash at very high frequencies as well as emitting light in direct proportion to the current running through it.

These features allow application in the most varied technological sectors and their use is becoming increasingly widespread; in particular, as set out in this descriptive context, the only recently discovered possibility of achieving LEDs with blue light emission, in addition to the red, orange, yellow and green light emission already achieved, has allowed reproducing, together with red and green radiation, a white light source, so that LEDs have also found application in outdoor and stage floodlights.

In this specific sector, the floodlights are composed of essentially flat and differently shaped screens as for perimeter dimensions, carrying a multiplicity of different-coloured LEDs arranged in rows behind respective lenses in such a way that by varying the intensity of the different-coloured light sources, they can provide iridescent light and thus also act as so-called “colour changers” for stage use.

### SUMMARY OF THE INVENTION

The main purpose of this invention, within this scope, is to provide a LED floodlight structure for stage or outdoor use such as to achieve variation of the width of the light beam produced, that is, variable focus.

Another purpose of this invention is to achieve the preceding purpose through a device easily adaptable to the LED floodlights according to the known technique.

Yet another purpose of this invention is to achieve the preceding purposes with a simple and effective device, safe in operation and at relatively low cost in consideration of the results practically achieved therewith.

These and other purposes are all achieved with the LED floodlight structure according to this invention, comprising an optical focus variation system composed of a matte screen (9) with adjustable excursion on whose surface are mounted a multiplicity of lenses (8) assembled distally within respective parallel telescopic tubes (6-7) fitted in correspondence to the light sources (4-5).

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Additional features and advantages of the structure according to this invention will appear more evident from the following detailed description of a currently preferred by nonetheless nonexclusive form of its realization, represented by way of example and not limited to the four drawings attached hereto, wherein:

FIG. 1 shows a perspective view of an LED floodlight for stage and outdoor use with the associated focus variation device according to this invention;

FIGS. 2 and 3 show an exploded view of the respective component parts of the LED floodlight of FIG. 1; and

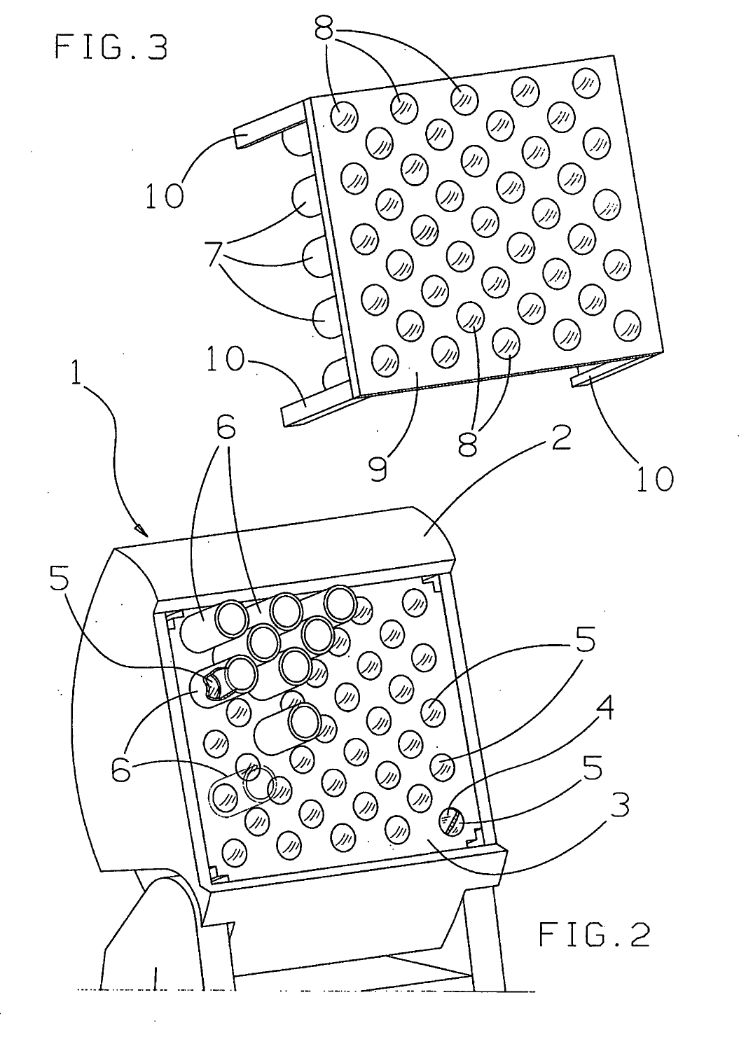

FIG. 4 shows a cross-section of a related part of the LED floodlight.

### DETAILED DESCRIPTION OF THE PRESENTLY PREFERRED EMBODIMENTS

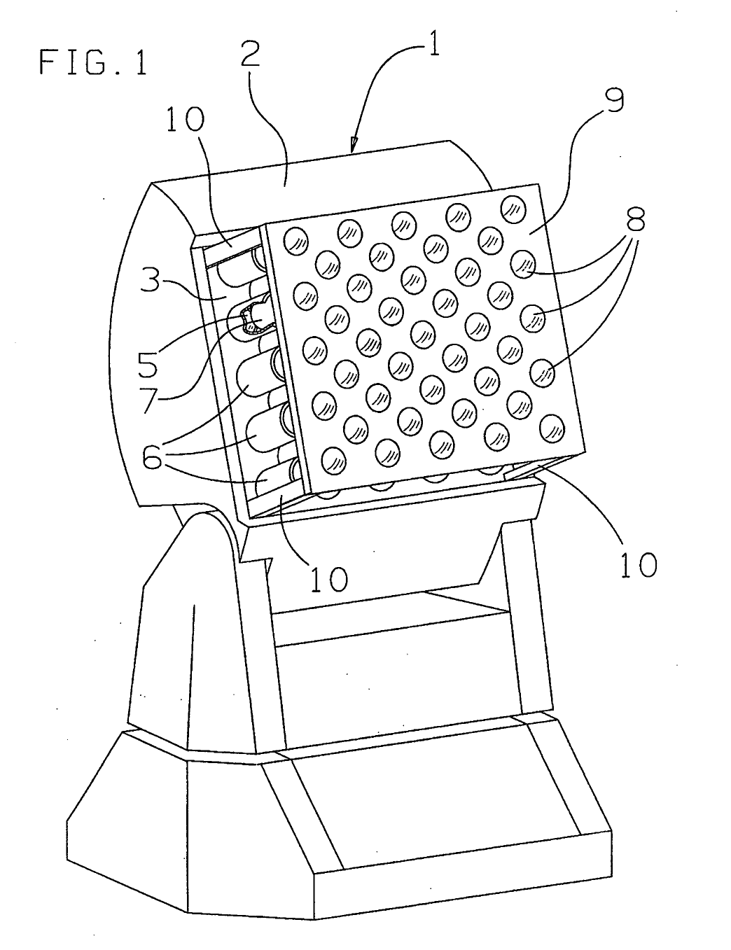

With reference to the drawing figures, and in particular to FIG. 1, reference numeral 1 indicates a complete LED floodlight in accordance with the invention for stage or outdoor use, comprising a swivel head (2) with rectangular luminous surface (3).

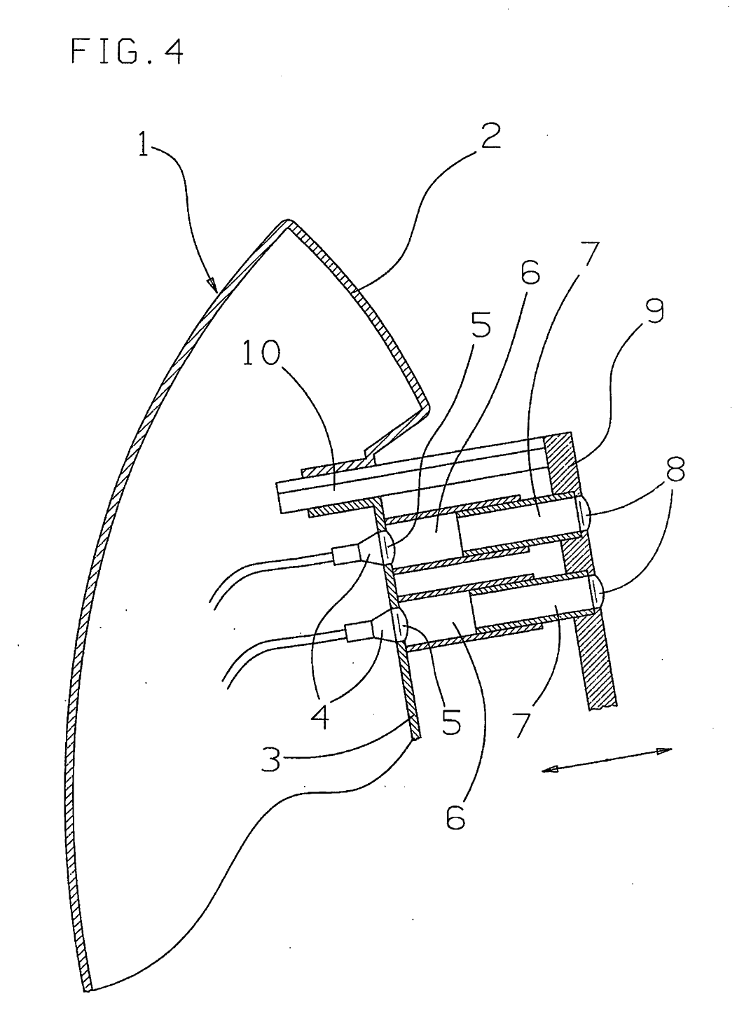

A multiplicity of different-coloured LEDs (4) are sunk in parallel rows in the luminous surface (3), each covered with a respective fixed lens (5) (also seen in FIG. 4).

A fixed portion (6) of a matte tube is coaxially disposed around each fixed lens (5), telescopically interacting with a respective movable portion (7) of the matte tube, at the apex of which a respective movable lens (8) is positioned.

The movable tubes (7) are distally assembled on a flat matte screen (9) on whose surface the movable lenses (8) are mounted in rows, and the screen is dimensioned and shaped like the luminous surface (3) of the head (2) parallel to it.

The matte screen (9) is assembled on four corner sliding guide rods (10) fitted in the head (2) with the rods interlocked with respective linear actuators (not illustrated) of any type suited to the purpose, for the functions specified below.

### Dynamic Description of the Preferred Embodiment

The operation of the LED floodlight structure according to the invention as hereinabove disclosed will now be described.

In the operation of the inventive apparatus the multiplicity of LEDs (4), which arranged in rows contribute to form the luminous surface (3) of the swivel head (2), can be activated to generate respective light beams that, instead of being immediately diffused through the fixed lenses (5) as is the case in prior art floodlights, are conveyed into the telescopic tubes (6 and 7) and diffused through the movable lenses (8) that are integral with the matte screen (9).

In this way, by selectively displacing the matte screen (9) the extension of the telescopic tubes (6 and 7) is uniformly varied for thereby uniformly varying the focus of the light beams—i.e., their width—that are generated by the LEDs (4) and, therewith, the beam generated by the floodlight as a whole, providing the ability to adapt the generated beams to the scontingent lighting requirements.

As should be evident, it is generally intended and preferred that this optical focus variation system be driven by electronic logic, preferably in combination with the electronic logic that controls activation of the light sources and variation of the relative luminescence, in order to achieve the variations in intensity of the projected overall light beam and the iridescence of the relative colours, so as to multiply the combinations of performance achievable by the device.

### Alternative Configurations

Those skilled in the art will appreciate that in additional alternative forms of implementation, nonetheless falling within the inventive concept implicit in the preferred implementation described hereinabove, the LED floodlight structure according to this invention can instead be implemented with equivalent techniques and structures, that is, equipped with additional integrated parts and devices, just as the forms and shapes of the constituent parts thereof can be altered in a manner suited to the intended usage or purpose as a general matter of design choice.

In particular:

The floodlight and the relative components may be shaped and dimensioned in any way.

The luminous surface and the screen may in their turn be shaped and dimensioned in any way.

The matte screen guide and movement system, i.e. for telescopic tube extension variation, may be of any type and kind suited to the purpose at hand.

### ADVANTAGES OF THE INVENTION

As will be evident from the preceding detailed description of a preferred illustrative implementation, the LED floodlight structure according to this invention offers the particular advantages for achievement of the intended objects of the invention as discussed hereinabove and for other purposes. In particular, it integrates a simple and effective means to achieve light beam variation in LED floodlights in combination with the other multiple purposes of these devices.

Thus, while there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An LED floodlight structure, comprising an optical focus variation system composed of a matte screen (9) with adjustable excursion on whose surface are mounted a multiplicity of lenses (8) assembled distally within respective parallel telescopic structures (6-7) fitted in correspondence to LED light sources (4-5).

2. An LED floodlight structure, comprising:
a multiplicity of LEDs (4) arranged over a luminous surface (3);
a fixed portion (6) of a matte tube around each of said LEDs (4);
a movable portion (7) of the matte tube telescopically interacting with each fixed portion (6) of the matte tube;
at least one movable lens (8) positioned at the apex of each movable portion (7) of the matte tube;
a matte screen (9) on which said movable telescopic tubes are distally assembled (7); and
means for moving said matte screen (9).

3. An LED floodlight structure in accordance with claim 2, wherein each of said LEDs (4) is covered by at least one respective fixed lens (5).

4. An LED floodlight structure in accordance with claim 2, wherein said moving means comprises four corner sliding guide rods (10) attached to said matte screen (9) and interlocked with linear actuators.

5. An LED floodlight structure in accordance with claim 2, wherein said LEDs (4) are sunk in parallel rows in the luminous surface (3).

6. An LED floodlight structure in accordance with claim 2, wherein said movable lenses (8) are mounted in rows on the surface of said matte screen (9).

7. An LED floodlight structure in accordance with claim 2, wherein said matte screen (9) is dimensioned and shaped like said luminous surface (3) parallel to it.

8. An LED floodlight structure in accordance with claim 2, wherein said matte screen (9) is flat.

9. An LED floodlight structure in accordance with claim 2, wherein said LEDs (4) are coloured in any combination.

10. An LED floodlight structure in accordance with claim 2, wherein the optical focus variation system is driven by electronic logic.
